(19) United States
(12) Patent Application Publication
(10) Pub. No.: US 2009/0284870 A1
(43) Pub. Date: Nov. 19, 2009

(54) HEAD SUSPENSION ASSEMBLY AND STORAGE MEDIUM DRIVE

(75) Inventors: Yusuke Nojima, Kawasaki (JP); Shinji Koganezawa, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/359,746

(22) Filed: Jan. 26, 2009

(30) Foreign Application Priority Data
May 16, 2008 (JP) 2008-129111

(51) Int. Cl. G11B 5/48

(52) U.S. Cl. 360/244; G9B/5.147

(57) ABSTRACT

An arm has one end coupled to a head suspension and the other end defining a domed surface in a head suspension assembly. The domed surface establishes point contact against the side surface of a head slider. The arm is designed to restrain the direction of application of a force along an imaginary plane including the back surface of the head slider. A piezoelectric element is bonded to the arm at a position between the one end and the other end of the arm. The head suspension assembly allows the arm to curve in response to expansion/shrinkage of the piezoelectric element. A driving force is applied from the arm to the head slider based on the curvature of the arm. Since point contact is established between the arm and the side surface of the head slider, the curvature of the arm cannot be restrained.

### CROSS-REFERENCE TO RELATED APPLICATION

This application is based upon and claims the benefit of priority from the prior Japanese Patent Application No. 2008-129111 filed on May 16, 2008, the entire contents of which are incorporated herein by reference.

### FIELD

The embodiments discussed herein are related to a head suspension assembly preferably incorporated in a storage medium drive, such as a hard disk drive, HDD.

### BACKGROUND

An actuator is fixed to the surface of a head suspension. The actuator includes a pair of arms to support a head slider. The tip ends of the arms are bonded to the head slider. A piezoelectric element is attached to the individual arm. Expansion/shrinkage of the piezoelectric element causes curvature of the arm. This curvature allows the head slider to move along the surface of the head suspension. Deviation is in this manner eliminated between the centerline of a recording track and an electromagnetic transducer on the head slider. The tip ends of the arms of the actuator are bonded to the side surfaces of the head slider, respectively. The piezoelectric elements are attached to the arms. Consequently, the bonding hinders the warp or deformation when the piezoelectric elements expand or shrink. The movement of the head slider is thus significantly restricted.

### SUMMARY

According to a first aspect of the invention, there is provided a head suspension assembly comprising: a head slider defining a medium-opposed surface on the front surface; a fixation piece fixed to the back surface, reverse to the front surface, of the head slider; a flexible elongated piece extending from the fixation piece, the flexible elongated piece coupled to a head suspension, the flexible elongated piece supporting the fixation piece for relative rotation around the rotation axis perpendicular to the medium-opposed surface of the head slider; an arm having one end coupled to the head suspension, the arm having the other end defining a domed surface establishing point contact against the side surface of the head slider set perpendicular to the medium-opposed surface of the head slider, the arm designed to restrain the direction of application of a force along an imaginary plane including the back surface of the head slider; and a piezoelectric element bonded to the arm at a position between the one end and the other end of the arm.

The head suspension assembly allows the arm to curve in response to expansion/shrinkage of the piezoelectric element. The arm allows the domed surface at the other end of the arm to contact with the side surface of the head slider. A driving force is applied from the arm to the head slider based on the curvature of the arm. The head slider is fixed to the fixation piece. The flexible elongated piece is utilized to couple the fixation piece to the head suspension. The deformation of the flexible elongated piece enables the movement of the head slider. The driving force thus makes the head slider move. Since point contact is established between the arm and the side surface of the head slider, the curvature of the arm cannot be restrained. Moreover, the arm is defined separately from the fixation piece. The arm can enjoy a wide variety of design. It is possible to ensure a sufficient length of the arm. A larger deformation of the arm can thus be realized. A larger movement of the head slider can be realized.

Moreover, point contact is established between the domed surface of the arm and the side surface of the head slider. The arm restrains the direction of application of a driving force along the imaginary plane including the back surface of the head slider. The head slider is allowed to reliably rotate around the rotation axis on the imaginary plane. The movement of the head slider is thus restricted in the direction parallel to the rotation axis, namely in the perpendicular direction perpendicular to the imaginary plane. The rotation of the head slider is restricted around the longitudinal center axis of the head slider. In other words, the driving force cannot generate a change in the roll angle of the head slider. The head slider can be kept at the flying height as designed above the surface of a recording medium when the head slider is driven to rotate around the rotation axis. The head slider is allowed to enjoy an improved positioning accuracy. The head suspension assembly is incorporated in a storage medium drive, for example.

According to a second aspect of the invention, the head suspension assembly comprises: a head slider defining a medium-opposed surface on the front surface; a fixation piece fixed to the back surface, reverse to the front surface, of the head slider, the fixation piece having the side surface extending along a plane intersecting the medium-opposed surface of the head slider; a flexible elongated piece extending from the fixation piece, the flexible elongated piece coupled to a head suspension, the flexible elongated piece supporting the fixation piece for relative rotation around the rotation axis perpendicular to the medium-opposed surface of the head slider; an arm having one end coupled to the head suspension, the arm having the other end defining a domed surface establishing point contact against the side surface of the fixation piece, the arm designed to restrain the direction of application of a force along an imaginary plane parallel to the medium-opposed surface of the head slider; and a piezoelectric element bonded to the arm at a position between the one end and the other end of the arm.

The head suspension assembly allows the arm to curve in response to expansion/shrinkage of the piezoelectric element in the same manner as described above. The arm allows the domed surface at the other end of the arm to contact with the side surface of the fixation piece. A driving force is applied from the arm to the head slider based on the curvature of the arm. The head slider is fixed to the fixation piece. The flexible elongated piece is utilized to couple the fixation piece to the head suspension. The deformation of the flexible elongated piece enables the movement of the head slider. The driving force thus makes the head slider move. Since point contact is established between the arm and the side surface of the fixation piece, the curvature of the arm cannot be restrained. Moreover, the arm is defined separately from the fixation piece. The arm can enjoy a wide variety of design. It is possible to ensure a sufficient length of the arm. A larger deformation of the arm can thus be realized. A larger movement of the head slider can be realized.

Moreover, point contact is established between the domed surface of the arm and the side surface of the fixation piece. The arm restrains the direction of application of a driving force along the imaginary plane parallel to the medium-opposed surface of the head slider. The fixation piece, namely the head slider, is allowed to reliably rotate around the rotation axis on the imaginary plane. The movement of the head slider is thus restricted in the direction parallel to the rotation axis, namely in the perpendicular direction perpendicular to the imaginary plane. The rotation of the head slider is restricted around the longitudinal center axis of the head slider. In other words, the driving force cannot generate a change in the roll angle of head slider. The head slider can be kept at the flying height as designed above the surface of a recording medium when the head slider is driven to rotate around the rotation axis. The head slider is allowed to enjoy an improved positioning accuracy. The head suspension assembly is incorporated in a storage medium drive, for example.

The objects and advantages of the invention will be realized and attained by means of the elements and combinations particularly pointed out in the claims. It is to be understood that both the foregoing general description and the following detailed description are exemplary and explanatory only and are not restrictive of the invention, as claimed.

### BRIEF DESCRIPTION OF THE DRAWINGS

FIG. 1 is a plan view schematically illustrating the structure of a storage medium drive, namely a hard disk drive, HDD, according to an embodiment of the present invention;

FIG. 2 is an enlarged partial perspective view schematically illustrating a head suspension assembly according to a first embodiment of the present invention;

FIG. 3 is an enlarged partial exploded perspective view schematically illustrating the head suspension assembly;

FIG. 4 is an enlarged partial perspective view schematically illustrating the head suspension assembly;

FIG. 5 is an enlarged partial plan view schematically illustrating the head suspension assembly;

FIG. 6 is an enlarged partial front view schematically illustrating the head suspension assembly;

FIG. 7 is a plan view schematically illustrating the clockwise rotation of the flying head slider;

FIG. 8 is a plan view schematically illustrating the anticlockwise rotation of the flying head slider;

FIG. 9 is an enlarged partial perspective view schematically illustrating a head suspension assembly according to a second embodiment of the present invention;

FIG. 10 is an enlarged partial front view schematically illustrating the head suspension assembly;

FIG. 11 is an enlarged partial perspective view schematically illustrating a head suspension assembly according to a third embodiment of the present invention; and

FIG. 12 is an enlarged partial front view schematically illustrating the head suspension assembly.

### DESCRIPTION OF EMBODIMENTS

Preferred embodiments of the invention will be explained below with reference to the accompanying drawings.

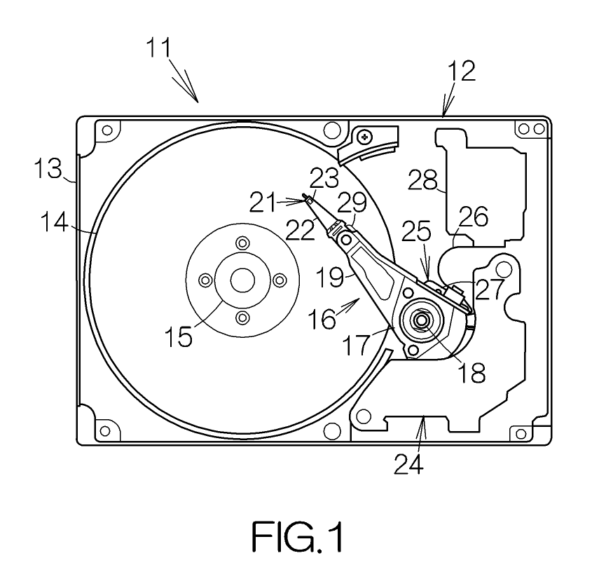

FIG. 1 schematically illustrates the structure of a hard disk drive, HDD, 11 as an example of a storage medium drive or a storage medium drive according to the present invention. The hard disk drive 11 includes an enclosure 12. The enclosure 12 includes a box-shaped base 13 and a cover, not shown. The base 13 defines an inner space in the form of a flat parallelepiped, for example. The base 13 may be made of a metallic material such as aluminum, for example. Molding process may be employed to form the base 13. The cover is coupled to the opening of the base 13. An inner space is defined between the base 13 and the cover. Pressing process may be employed to form the cover out of a plate material, for example.

At least one magnetic recording disk 14 as a storage medium is enclosed in the enclosure 12. The magnetic recording disk or disks 14 are mounted on the driving shaft of a spindle motor 15. The spindle motor 15 drives the magnetic recording disk or disks 14 at a higher revolution speed such as 3,600 rpm, 4,200 rpm, 5,400 rpm, 7,200 rpm, 10,000 rpm, 15,000 rpm, or the like.

A carriage 16 is also enclosed in the enclosure 12. The carriage 16 includes a carriage block 17. The carriage block 17 is supported on a vertical support shaft 18 for relative rotation. Carriage arms 19 are defined in the carriage block 17. The carriage arms 19 extend in the horizontal direction from the vertical support shaft 18. The carriage block 17 may be made of aluminum, for example. Extrusion molding process may be employed to form the carriage block 17, for example.

A head suspension assembly 21 is attached to the front or tip end of the individual carriage arm 19. The head suspension assembly 21 includes a head suspension 22 extending forward from the tip end of the carriage arm 19. A flexure is attached to the surface of the head suspension 22. The flexure will be described later in detail. A flying head slider 23 is supported on the flexure. A magnetic head or electromagnetic transducer is mounted on the flying head slider 23.

When the magnetic recording disk 14 rotates, the flying head slider 23 is allowed to receive airflow generated along the rotating magnetic recording disk 14. The airflow serves to generate a positive pressure or a lift as well as a negative pressure on the flying head slider 23. The lift is balanced with a combination of the negative pressure and the urging force of the head suspension 22, so that the flying head slider 23 is allowed to keep flying above the surface of the magnetic recording disk 14 during the rotation of the magnetic recording disk 14 at a higher stability.

When the carriage 16 swings around the vertical support shaft 18 during the flight of the flying head slider 23, the flying head slider 23 is allowed to move along the radial direction of the magnetic recording disk 14. The electromagnetic transducer on the flying head slider 23 is allowed to cross the data zone defined between the innermost and outermost recording tracks. The electromagnetic transducer on the flying head slider 23 can thus be positioned right above a target recording track on the magnetic recording disk 14.

A power source such as a voice coil motor, VCM, 24 is connected to the carriage block 17. The voice coil motor 24 serves to drive the carriage block 17 around the vertical support shaft 18. The rotation of the carriage block 17 allows the carriage arms 19 and the head suspensions 22 to swing.

As is apparent from FIG. 1, a flexible printed circuit board unit 25 is located on the carriage block 17. The flexible printed circuit board unit 25 includes a head IC (integrated circuit) 27 mounted on a flexible printed wiring board 26. The head IC 27 is designed to supply the read element of the electromagnetic transducer with a sensing current when the magnetic bit data is to be read. The head IC 27 is also designed to supply the write element of the electromagnetic transducer with a writing current when the magnetic bit data is to be written. A small-sized circuit board 28 is located within the inner space of the enclosure 12. A printed wiring board, not shown, is attached to the outward surface of the bottom plate of the base 13. The small-sized circuit board 28 and the printed wiring board on the bottom plate are designed to supply the head IC 27 with the sensing current and the writing current.

A flexure 29 is utilized to relay the sensing current and the writing current to the electromagnetic transducer. A wiring is formed in the flexure 29 as described later. One end of the flexure 29 is attached to the individual head suspension 22. The flexure 29 extends backward from the head suspension 22 along the side of the carriage arm 19. The other end of the flexure 29 is overlaid on the flexible printed wiring board 26. The flexure 29 is connected to the flexible printed circuit board unit 25. The sensing current and the wiring current are supplied from the head IC 27 to the flying head slider 23 through the flexure 29. The head suspension assembly 21 has the structure of a so-called long-tail.

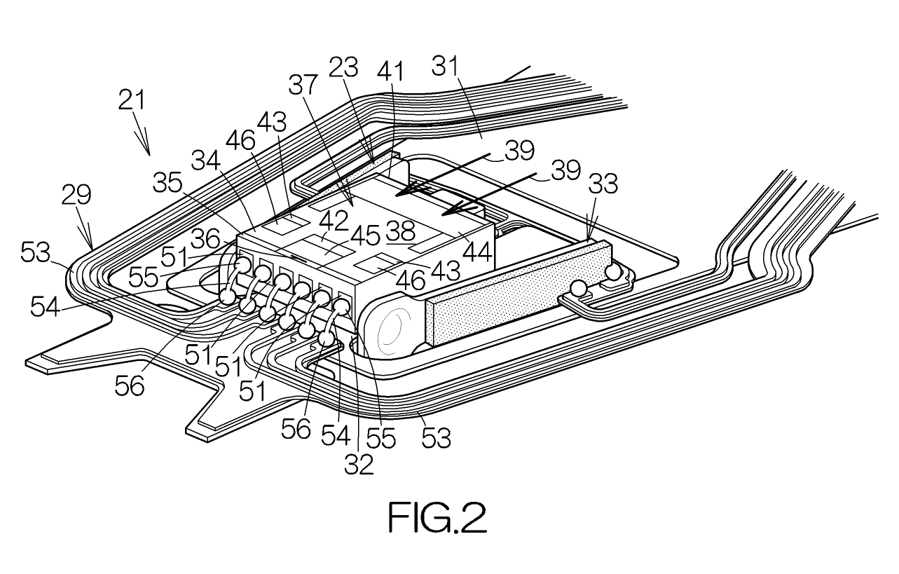

FIG. 2 schematically illustrates the head suspension assembly 21 according to a first embodiment of the present invention. In the head suspension assembly 21, the flexure 29 includes a fixation plate 31 fixed to the head suspension 22. A gimbal 32 is connected to the fixation plate 31. The gimbal 32 changes its attitude relative to the fixation plate 31. The fixation plate 31 and the gimbal 32 are made out of a single leaf spring material. The leaf spring material may be a stainless steel plate having a constant thickness, for example. A microactuator 33 is fixed to the surface of the gimbal 32. The flying head slider 23 is supported on the microactuator 33. Detailed description will later be made on the microactuator 33.

The flying head slider 23 includes a slider body 34 in the form of a flat parallelepiped, for example. A non-magnetic film, namely a head protection film 35, is overlaid on the outflow or trailing end surface of the slider body 34. The aforementioned electromagnetic transducer 36 is incorporated in the head protection film 35. The slider body 34 may be made of a hard material such as Al₂O₃—TiC. The head protection film 35 may be made of a relatively soft material such as Al₂O₃ (alumina). The flying head slider 23 defines a medium-opposed surface or bottom surface 37 so as to face the magnetic recording disk 14 at a distance. A flat base surface 38 is defined on the bottom surface 37. When the magnetic recording disk 14 rotates, airflow 39 flows along the bottom surface 37 from the inflow or front end toward the outflow or rear end of the slider body 34.

A front rail 41 is formed on the bottom surface 37 of the slider body 34. The front rail 41 stands upright from the base surface 38 at a position near the upstream or inflow end of the slider body 34. The front rail 41 extends along the inflow end of the base surface 38 in the lateral direction of the slider body 34. A rear rail 42 is likewise formed on the bottom surface 37 of the slider body 34. The rear rail 42 stands upright from the base surface 38 at a position near the downstream or outflow end of the slider body 34. The rear rail 42 is located at the intermediate position in the lateral direction of the slider body 34. The rear rail 42 extends from the slider body 34 to the head protection film 35. A pair of side rear rails 43, 43 is also formed on the bottom surface 37 of the slider body 34. The side rear rails 43, 43 stand upright from the base surface 38 at positions near the downstream or outflow end of the slider body 34. The rear rail 42 is located at a position between the side rear rails 43, 43.

So-called air bearing surfaces 44, 45, 46 are defined on the top surfaces of the front rail 41, the rear rail 42 and the side rear rails 43, 43, respectively. Steps are formed at the inflow ends of the air bearing surfaces 44, 45, 46 so as to connect the inflow ends to the top surfaces of the corresponding rails 41, 42, 43, respectively. The airflow 39 is generated along the surface of the rotating magnetic recording disk 14. The airflow 39 flows along the bottom surface 37 of the slider body 34. The steps serve to generate a relatively large positive pressure or lift on the air bearing surfaces 44, 45, 46, respectively. A large negative pressure is generated behind the front rail 41. The negative pressure is balanced with the lift so as to establish the flying attitude of the flying head slider 23.

The electromagnetic transducer 36 is embedded within the rear rail 42. The electromagnetic transducer 36 is exposed on the air bearing surface 45. The electromagnetic transducer 36 may include a read head element utilized to read data from the magnetic recording disk 14, and a write head element utilized to write data in the magnetic recording disk 14, for example. The read head element may be a giant magnetoresistive (GMR) element, a tunnel-junction magnetoresistive (TMR), or the like. The write head element may be a thin film magnetic head, or the like. It should be noted that the flying head slider 23 can take any shape or form different from the described one.

First, second and third pairs of electrode terminals 51 are located at the outflow end surface of the flying head slider 23, namely of the head protection film 35. The first pair of electrode terminals 51 is electrically connected to the read head element of the electromagnetic transducer 36, for example. The sensing current is supplied to the read head element through the electrode terminals 51 of the first pair. A variation is observed in the voltage of the sensing current through the electrode terminals 51 of the first pair. The second pair of electrode terminals 51 is electrically connected to the write head element of the electromagnetic transducer 36. The writing current is supplied to the write head element through the electrode terminals 51, for example. A magnetic field is generated in a thin film coil pattern in response to the supply of the writing current, for example. The third pair of the electrode terminals 51 is connected to a heater located at a position adjacent to the electromagnetic transducer 36, for example. Heat generated in the heater makes the electromagnetic transducer 36 to project. The flying height of the electromagnetic transducer 36 is adjusted based on such a projection.

Wiring patterns 53 are formed on the fixation plate 31 of the flexure 29. Electrically-conductive wires 54 are utilized to connect the wiring patterns 53 to the electrode terminals 51. The individual electrically-conductive wire 54 includes a first joint 55 and a second joint 56. The first joint 55 stands upright from the surface of the electrode terminal 51. The second joint 56 stands upright from the surface of the wiring pattern 53. The first and second joints 55, 56 are connected to each other through a wire body 57. The curvature of the wire body 57 absorbs an angle between the first and second joints 55, 56. A so-called wire bonding method is employed to form the electrically-conductive wire 54. The individual wiring pattern 53 includes an insulating layer, an electrically-conductive layer and a protection layer overlaid on the fixation plate 31 in this sequence. The insulating layer and the protection layer are made of a resin material such as polyimide resin, for example. The electrically-conductive layer is made of an electrically-conductive material such as copper, for example.

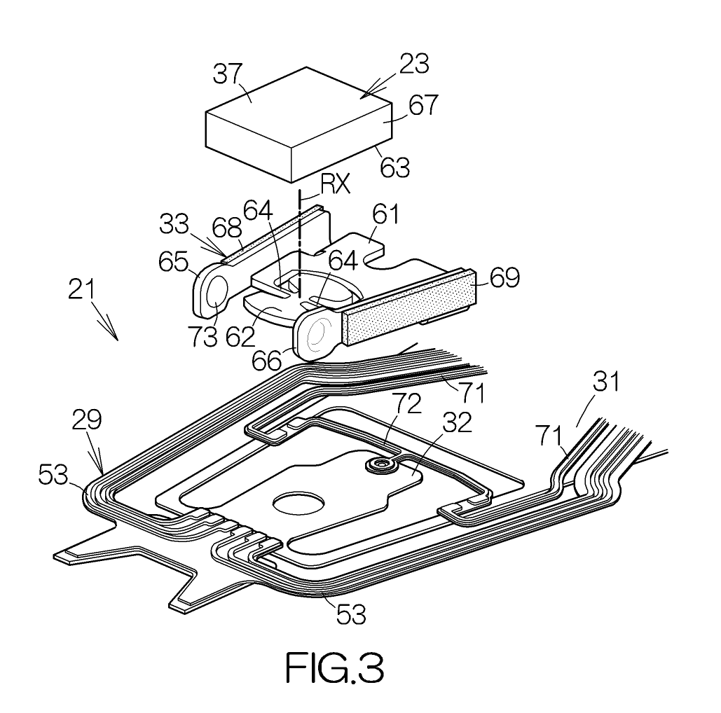

As shown in FIG. 3, the microactuator 33 includes a support piece 61. The support piece 61 extends along the surface of the gimbal 32. The back surface of the support piece 61 is bonded to the surface of the gimbal 32. A fixation piece 62 is supported on the support piece 61. The fixation piece 62 is located at a position downstream of the support piece 61. The fixation piece 62 is bonded to the back surface 63, reverse to the bottom surface 37, of the flying head slider 23. The fixation piece 62 extends around the rotation axis RX perpendicular to the bottom surface 37. Here, the rotation axis RX penetrates the centroid of the flying head slider 23. Flexible elongated pieces 64, 64 are utilized to connect the support piece 61 to the fixation piece 62. The flexible elongated pieces 64 are coupled to the constriction of the fixation piece 62, for example. The support piece 61, the fixation piece 62 and the flexible elongated pieces 64 have the same thickness.

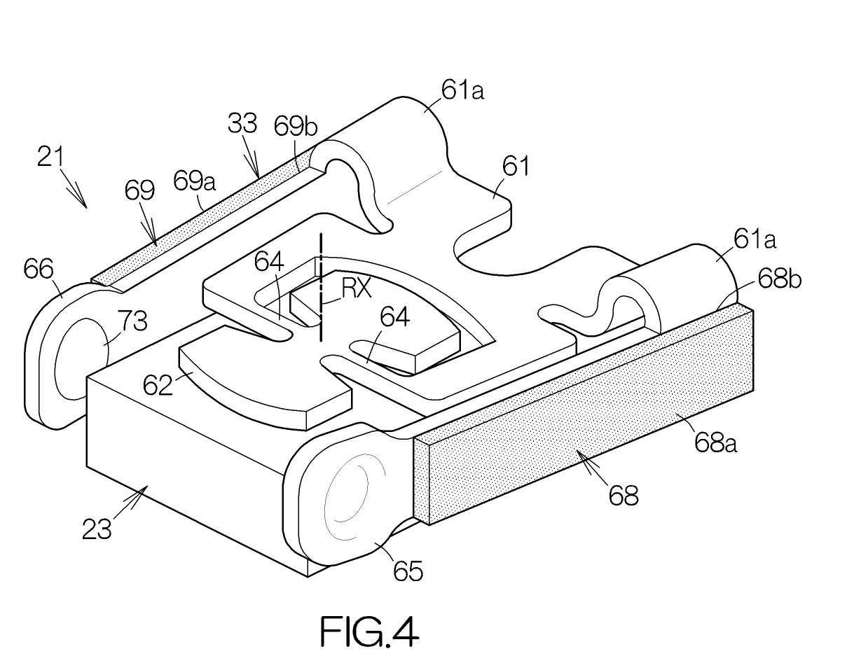

Referring also to FIG. 4, the flexible elongated pieces 64 extend along an imaginary plane perpendicular to the rotation axis RX in the lateral direction of the flying head slider 23. The flexible elongated pieces 64 extend in parallel with the outflow and inflow ends of the flying head slider 23. The flexible elongated pieces 64 are deformable. The deformation of the flexible elongated pieces 64 allows the rotation of the fixation piece 62 around the rotation axis RX, as described later. Since the support piece 61 is fixed to the gimbal 32 of the flexure 29, the support piece 61 is prevented from deformation irrespective of the rotation of the fixation piece 62. Likewise, since the fixation piece 62 is fixed to the flying head slider 23, the fixation piece 62 is prevented from deformation during the rotation thereof. The support piece 61 defines curved portions 61a coupled to a first arm 65 and a second arm 66. The curved portions 61a are located at positions upstream of the inflow end of the flying head slider 23. The individual curved portion 61a is formed in the semicylindrical shape around a longitudinal center axis parallel to the side edges of the back surface 63 of the flying head slider 23.

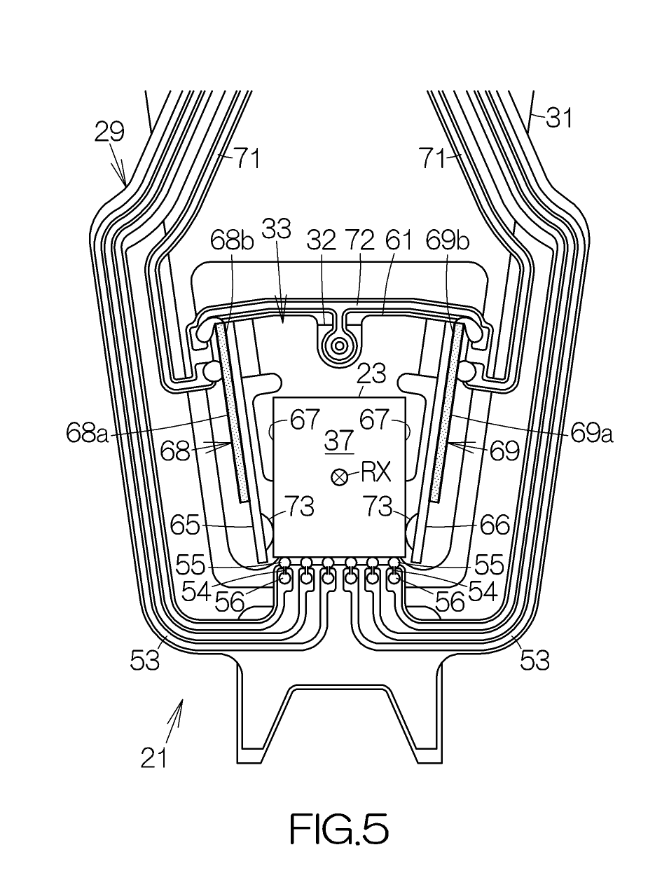

Referring also to FIG. 5, one ends, namely the root ends, of the first and second arms 65, 66 are coupled to the support piece 61 at a position upstream of the inflow end of the flying head slider 23. The other ends, namely the tip ends, of the first and second arms 65, 66 are received or contact on the side surfaces 67 of the flying head slider 23 at positions downstream of the rotation axis RX. The side surfaces 67 are set perpendicular to the bottom surface 37 in the flying head slider 23. The flying head slider 23 is located in a space defined between the first arm 65 and the second arm 66. The first arm 65 extends along an imaginary plane set parallel to the rotation axis RX. Likewise, the second arm 66 extends along an imaginary plane set parallel to the rotation axis RX.

The inward surfaces of the first and second arms 65, 66 are opposed to each other. The first arm 65 and the second arm 66 get closer to each other as the position gets closer to the tip ends thereof from the root ends thereof. A first piezoelectric element 68 is attached to the outward surface of the first arm 65. Likewise, a second piezoelectric element 69 is attached to the outward surface of the second arm 66. The first piezoelectric element 68 and the second piezoelectric element 69 are made out of a thin plate of piezoelectric ceramic, for example. Such a thin plate of piezoelectric ceramic may be made of a piezoelectric material such as PNN-PT-PZ, for example.

The inward surfaces of the first piezoelectric element 68 and the second piezoelectric element 69 are bonded to the first arm 65 and the second arm 66, respectively. The first and second piezoelectric elements 68, 69 have one ends on the first arm 65 and the second arm 66 at positions upstream of the inflow end of the flying head slider 23, respectively. The first and second piezoelectric elements 68, 69 have the other ends on the first arm 65 and the second arm 66 at positions downstream of the rotation axis RX, respectively. In this manner, the first piezoelectric element 68 is located between one end and the other end of the first arm 65 while the second piezoelectric element 69 is located between one end and the other end of the second arm 66.

First electrodes 68a, 69a are formed on the outward surfaces of the thin plates of piezoelectric ceramic, respectively. Second electrodes 68b, 69b are formed on the inward surfaces of the thin plates of piezoelectric ceramic, respectively. Electrically-conductive patterns 71 are connected to the first electrodes 68a, 69a, respectively. Likewise, electrically-conductive patterns 72 are connected to the second electrodes 68b, 69b, respectively. An electrically-conductive adhesive may be utilized for the connection between the patterns 71, 72 and the electrodes 68a, 69a, 68b, 69b. The electrically-conductive patterns 71, 72 are each formed on an insulating layer. The insulating layer is made of polyimide resin, for example. The electrically-conductive patterns 71 are connected to the head IC 27. The electrically-conductive patterns 72 are connected to the gimbal 32.

Polarization is established in the first piezoelectric element 68 in the direction from the second electrode 68b to the first electrode 68a. Likewise, polarization is established in the second piezoelectric element 69 in the direction from the second electrode 69b to the first electrode 69a. When a driving voltage is applied to the first electrodes 68a, 69a, the voltage acts on the first and the second piezoelectric elements 68, 69 in the direction opposite to the polarization. The first and second piezoelectric elements 68, 69 thus shrink in the direction of the polarization. The first piezoelectric element 68 expands along the surface of the first arm 65. The expansion of the first piezoelectric element 68 causes curvature of the first arm 65. The tip end of the first arm 65 is driven to move toward the second arm 66. A driving force is applied from the tip end of the first arm 65 to the side surface 67 of the flying head slider 23. Likewise, the second piezoelectric element 69 expands along the surface of the second arm 66. The expansion of the second piezoelectric element 69 causes curvature of the second arm 66. The tip end of the second arm 66 is driven to move toward the first arm 65. A driving force is applied from the second arm 66 to the side surface 67 of the flying head slider 23.

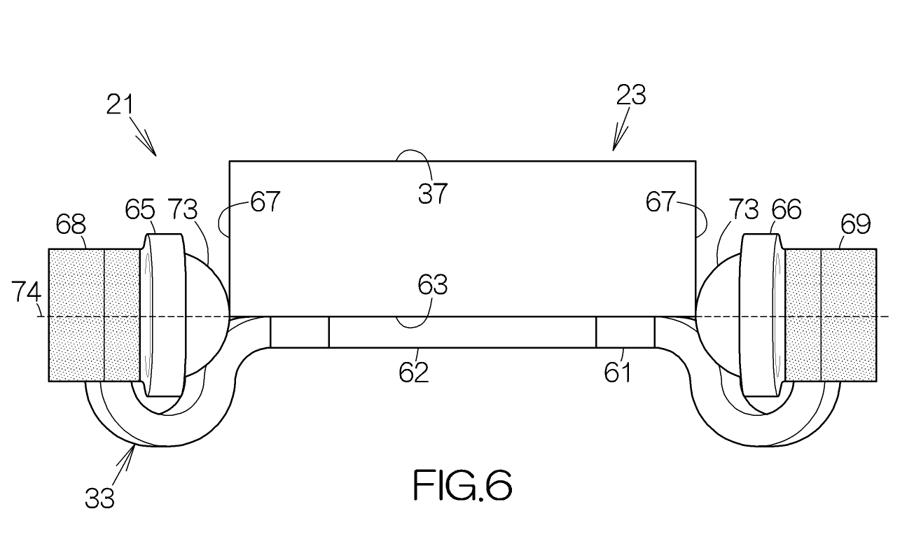

Domed surfaces 73 are defined in the first arm 65 and the second arm 66, respectively. The domed surfaces 73 swell to get closer to each other. The domed surfaces 73 are formed in the shape of a semisphere. Referring also to FIG. 6, the domed surfaces 73 of the first and second arms 65, 66 contact with the side surfaces 67 of the flying head slider 23, respectively. Point contact is thus established between the first arm 65 and the corresponding side surface 67 as well as between the second arm 66 and the corresponding side surface 67. Here, the domed surfaces 73 contact with the side surfaces 67 of the flying head slider 23 on the lower edges of the side surfaces 67, namely on the boundaries between the side surfaces 67 and the back surface 63, respectively. In this manner, the first arm 65 and the second arm 66 are designed to restrain the direction of application of the driving force along an imaginary plane 74 including the back surface 63 of the flying head slider 23. Here, the direction of application of the driving force is set within the imaginary plane 74.

In the microactuator 33, the support piece 61, the fixation piece 62, the flexible elongated pieces 64, the first arm 65 and the second arm 66, and the first piezoelectric element 68 and the second piezoelectric element 69 are symmetrically formed relative to the imaginary plane extending in the longitudinal direction of the flying head slider 23 and including the rotation axis RX. The support piece 61, the fixation piece 62, the flexible elongated pieces 64, the first arm 65 and the second arm 66 in combination serve as an actuator body. The actuator body is made out of a single stainless steel plate. The thickness of the stainless steel plate is set at 50 μm approximately, for example. Punching process is employed to form the domed surfaces 73 in the first arm 65 and the second arm 66, for example.

Now, assume that the electromagnetic transducer 36 on the flying head slider 23 is positioned right above a target recording track on the magnetic recording disk 14. Here, a driving voltage is applied to the first piezoelectric element 68 and the second piezoelectric element 69 in response to instructions from a controller chip in the hard disk drive 11. The maximum value of the driving voltage is set at 20V. The value of the driving voltage ranges from 0V to 20V. The driving voltage of 10V is initially applied to the first piezoelectric element 68 and the second piezoelectric element 69. A driving force acts from the domed surface 73 of the first arm 65 in the direction toward the second arm 66 within the imaginary plane 74. Likewise, a driving force acts from the domed surface 73 of the second arm 66 in the direction toward the first arm 65 within the imaginary plane 74. These two driving forces are balanced with each other. The flying head slider 23 is thus kept at a neutral position, namely kept in a reference attitude. The driving voltage applied to the second piezoelectric element 69 is designed to change in the phase inverted to the phase of the driving voltage applied to the first piezoelectric element 68.

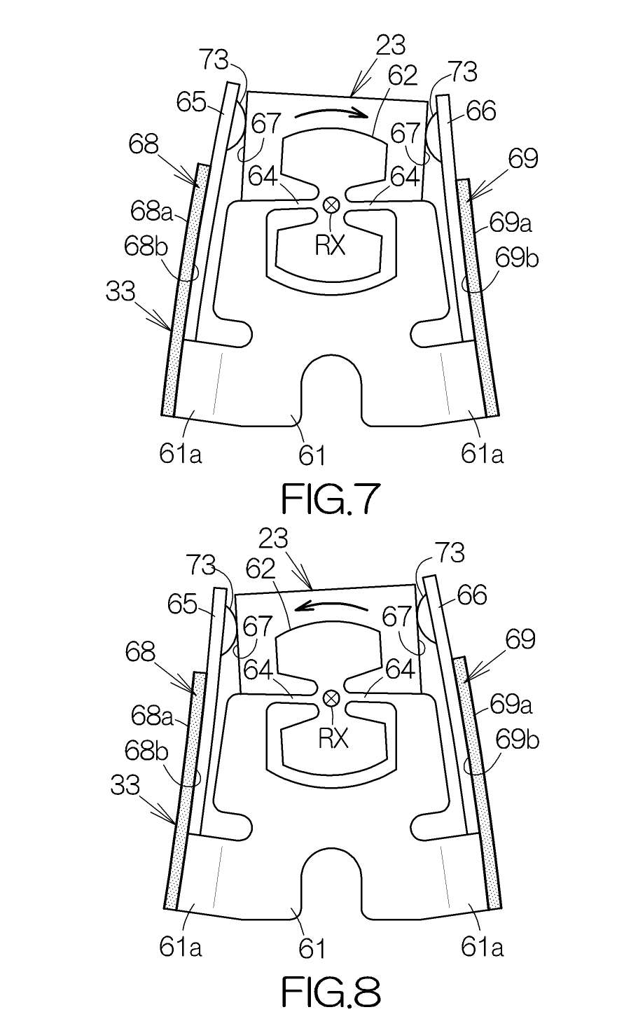

The read head element reads a servo pattern from the magnetic recording disk 14 in the tracking control. A deviation is detected between the read head element and the centerline of the recording track based on the read signal from the servo pattern. The driving voltage applied to the first piezoelectric element 68 is increased from 10V in accordance with the detected deviation. Simultaneously, the driving voltage applied to the second piezoelectric element 69 is reduced from 10V. The first piezoelectric element 68 further expands along the surface of the first arm 65. The first arm 65 is bent. This results in an increase in the driving force applied from the domed surface 63 in the direction toward the second arm 66 within the imaginary plane 74. Simultaneously, expansion of the second piezoelectric element 69 is reduced. The curvature of the second arm 66 decreases. This results in a reduction in the driving force from the domed surface 73 in the direction toward the first arm 65 along the imaginary plane 74. The flexible elongated pieces 64, 64 deform. The clockwise rotation of the fixation piece 62, namely the flying head slider 23, is caused around the rotation axis RX. In this case, the domed surface 73 of the first arm 65 is allowed to slide on the side surface 67 of the flying head slider 23 during the rotation of the flying head slider 23. Likewise, the domed surface 73 of the second arm 66 is allowed to slide on the side surface 67 of the flying head slider 23. The flying head slider 23 is driven to rotate around the rotation axis RX from the reference attitude, as shown in FIG. 7. The rotation of the flying head slider 23 allows the electromagnetic transducer 36 to move in the radial direction of the magnetic recording disk 14. It is expected to cancel the deviation in this manner.

In the case where the driving voltage applied to the first piezoelectric element 68 is reduced from 10V, the driving voltage applied to the second piezoelectric element 69 is increased from 10V. Expansion of the first piezoelectric element 68 is reduced. The curvature of the first arm 65 decreases. This results in a reduction in the driving force from the domed surface 73 in the direction toward the second arm 66 within the imaginary plane 74. At the same time, the second piezoelectric element 69 further expands along the surface of the second arm 66. The second arm 66 is curved. This results in an increase in the driving force from the domed surface 73 in the direction toward the first arm 65 within the imaginary plane 74. The flexible elongated pieces 64, 64 thus deform. The anticlockwise rotation of the fixation piece 62, namely the flying head slider 23, is caused around the rotation axis RX. The domed surface 73 of the first arm 65 is allowed to slide on the side surface 67 of the flying head slider 23. Likewise, the domed surface 73 of the second arm 66 is allowed to slide on the side surface 67 of the flying head slider 23. The flying head slider 23 is driven to rotate around the rotation axis RX from the reference attitude, as shown in FIG. 8. The rotation of the flying head slider 23 allows the electromagnetic transducer 36 to move in the radial direction of the magnetic recording disk 14 in the direction opposite to the aforementioned one. It is expected to cancel the deviation in this manner. The electromagnetic transducer 36 is allowed to follow the target recording track with a higher accuracy.

In the head suspension assembly 21, the position of the electromagnetic transducer 36 is slightly adjusted by rotating the flying head slider 23. Expansion/shrinkage of the first piezoelectric element 68 and the second piezoelectric element 69 causes curvature of the first arm 65 and the second arm 66. A driving force is thus applied to the flying head slider 23 from the first arm 65 and the second arm 66. The driving force allows the flying head slider 23 to rotate around the rotation axis RX. Since point contact is established between the first and second arms 65, 66 and the side surfaces 67 of the flying head slider 23, respectively, the first arm 65 and the second arm 66 are allowed to slide on the side surfaces 67 of the flying head slider 23. Curvature of the first arm 65 and the second arm 66 cannot thus be restrained. In addition, the fixation piece 62 is defined separately from the first arm 65 and the second arm 66. The first arm 65 and the second arm 66 can enjoy a wide variety of design. It is thus possible to ensure a sufficient length of the first arm 65 and the second arm 66. A larger deformation of the first arm 65 and the second arm 66 can be realized. A larger movement of the flying head slider 23 can be realized.

In addition, point contact is established between the domed surfaces 73 of the first and second arms 65, 66 and the side surfaces 67 of the flying head slider 23, respectively. The first arm 65 and the second arm 66 are designed to restrain the direction of application of the driving force within the imaginary plane 74 including the back surface 63 of the flying head slider 23. The flying head slider 23 is driven to rotate around the rotation axis RX along the imaginary plane 74. The movement of the flying head slider 23 is thus restricted in the direction parallel to the rotation axis RX, namely in the perpendicular direction perpendicular to the imaginary plane 74. The rotation of the flying head slider 23 is restricted around the longitudinal center axis of the flying head slider 23. In other words, the driving force cannot generate a change in the roll angle of flying head slider 23. The electromagnetic transducer 36 can be kept at the flying height as designed above the surface of the magnetic recording disk 14 when the flying head slider 23 is driven to rotate around the rotation axis RX. The electromagnetic transducer 36 is allowed to enjoy an improved positioning accuracy.

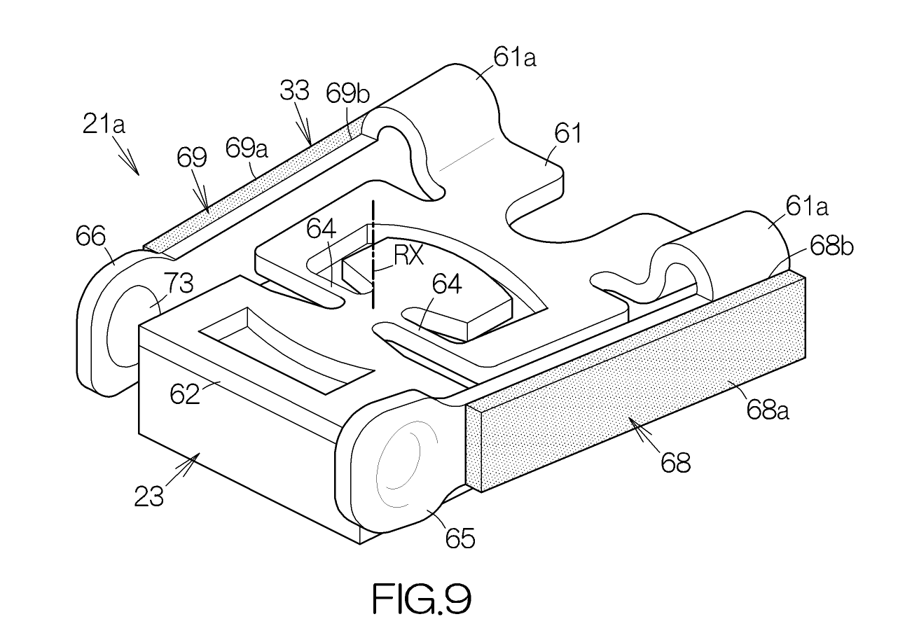

FIG. 9 schematically illustrates a head suspension assembly 21a according to a second embodiment of the present invention. In the head suspension assembly 21a, the fixation piece 62 includes a section, located downstream of the flexible elongated arms 64, extending to reach the outflow edge of the back surface 63 of the flying head slider 23. Simultaneously, the section of the fixation piece 62 extends to reach the side edges of the back surface 63 of the flying head slider 23. The front surface of the fixation piece 62 may be bonded to the back surface 63 of the flying head slider 23 over the entire area of the front surface.

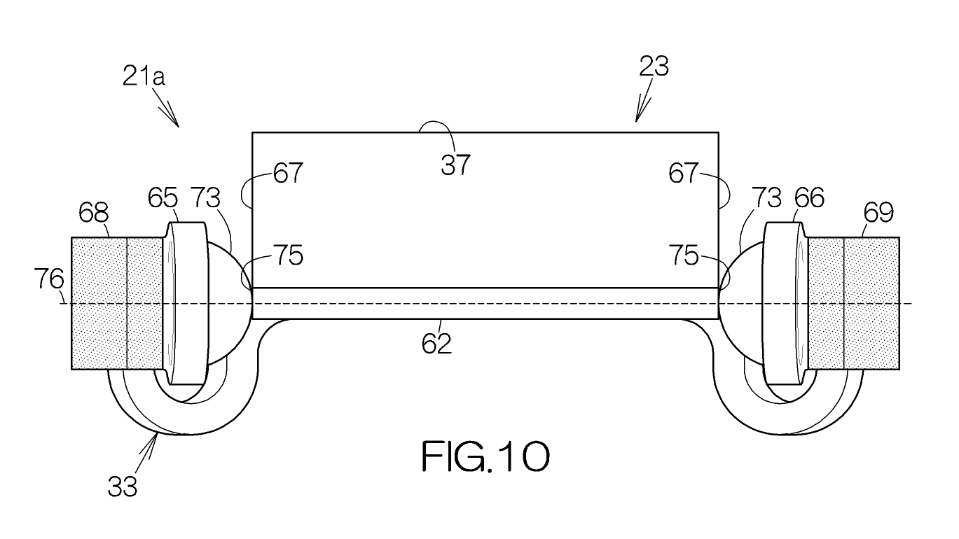

As shown in FIG. 10, point contact is established between the domed surfaces 73 of the first and second arms 65, 66 and side surfaces 75 of the fixation piece 62, respectively. The side surfaces 75 are set flush with the corresponding side surfaces 67 of the flying head slider 23 within respective vertical planes, respectively. The first arm 65 and the second arm 66 are designed to restrain the direction of application of the driving force along an imaginary plane 76 set parallel to the bottom surface 37. Here, point contact is established between the domed surfaces 73 and the side surfaces 75 of the fixation piece 62 at positions within the imaginary plane 76, respectively. The driving force is applied in the directions set within the imaginary plane 76. The imaginary plane 76 coincides with an intermediate plane defined in the fixation piece 62 at a position equally spaced from the front and back surfaces of the fixation piece 62. Like reference numerals are attached to the structure or components equivalent to those of the aforementioned head suspension assembly 21.

In the head suspension assembly 21a, expansion/shrinkage of the first piezoelectric element 68 and the second piezoelectric element 69 causes curvature of the first arm 65 and the second arm 66 in the same manner as described above. A driving force is thus applied to the flying head slider 23 from the first arm 65 and the second arm 66. The driving force allows the flying head slider 23 to rotate around the rotation axis RX. Since point contact is established between the first and second arms 65, 66 and the side surfaces 75 of the fixation piece 62, respectively, curvature of the first arm 65 and the second arm 66 cannot thus be restrained. In addition, the fixation piece 62 is defined separately from the first arm 65 and the second arm 66. The first arm 65 and the second arm 66 can enjoy a wide variety of design. It is thus possible to ensure a sufficient length of the first arm 65 and the second arm 66. A larger deformation of the first arm 65 and the second arm 66 can be realized. A larger movement of the flying head slider 23 can be realized.

In addition, point contact is established between the domed surfaces 73 of the first and second arms 65, 66 and the side surfaces 75 of the fixation piece 62, respectively. The first arm 65 and the second arm 66 are designed to restrain the direction of application of the driving force within the imaginary plane 76 parallel to the bottom surface 37 of the flying head slider 23, respectively. The fixation piece 62, namely the flying head slider 23, is allowed to reliably rotate around the rotation axis RX on the imaginary plane 76. The movement of the flying head slider 23 is thus restricted in the direction parallel to the rotation axis RX, namely in the perpendicular direction perpendicular to the imaginary plane 76. The rotation of the flying head slider 23 is restricted around the longitudinal center axis of the flying head slider 23. In other words, the driving force cannot generate a change in the roll angle of flying head slider 23. The electromagnetic transducer 36 can be kept at the flying height as designed above the surface of the magnetic recording disk 14 when the flying head slider 23 is driven to rotate around the rotation axis RX. The electromagnetic transducer 36 is allowed to enjoy an improved positioning accuracy.

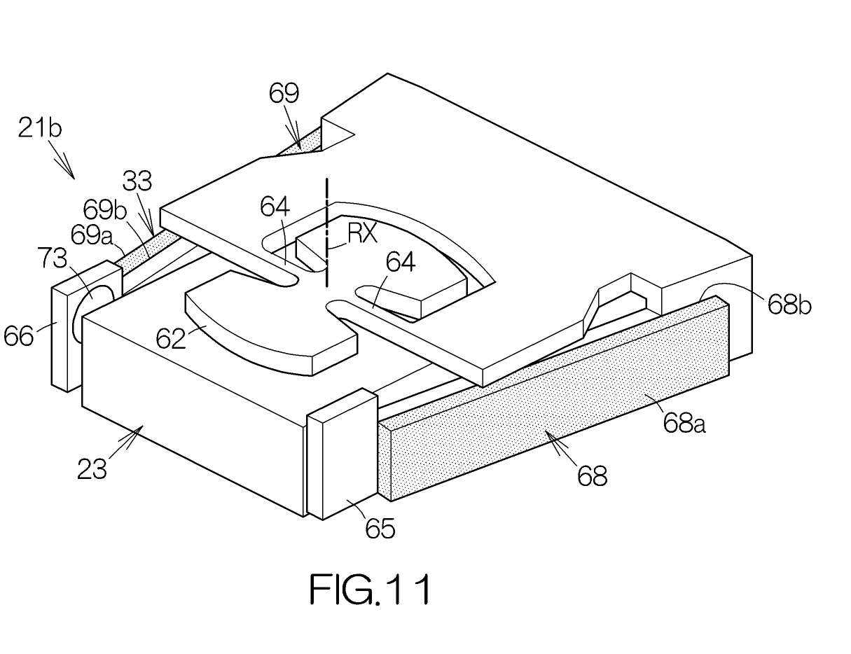

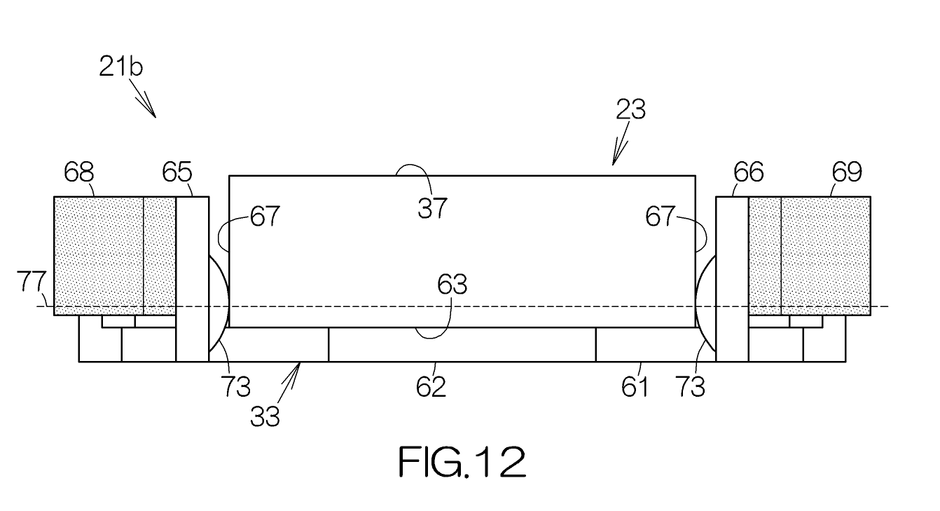

FIG. 11 schematically illustrates a head suspension assembly 21b according to a third embodiment of the present invention. In the head suspension assembly 21b, the first arm 65 and the second arm 66 bend from the support piece 61. The aforementioned curved portions 61a is omitted. The actuator body is made out of a stainless steel plate based on bending process, for example. Referring also to FIG. 12, point contact is established between the domed surfaces 73 of the first and second arms 65, 66 and the side surfaces 67 of the flying head slider 23, respectively. Here, the point contact is established at positions within an imaginary plane 77 parallel to the bottom surface 37, respectively. The direction of application of the driving force is set within the imaginary plane 77. The imaginary plane 77 is preferably defined at the position as closer to an intermediate plane as possible. The intermediate plane is defined at a position equally spaced from the front and back surfaces of the fixation piece 62. Like reference numerals are attached to the structure or components equivalent to those of the aforementioned head suspension assemblies 21, 21a.

In the head suspension assembly 21b, expansion/shrinkage of the first piezoelectric element 68 and the second piezoelectric element 69 causes curvature of the first arm 65 and the second arm 66 in the same manner as described above. A driving force is thus applied to the side surfaces 67 of the flying head slider 23 from the first and second arms 65, 66, respectively. The driving force allows the flying head slider 23 to rotate around the rotation axis RX on the imaginary plane 77. Since point contact is established between the first and second arms 65, 66 and the side surfaces 67 of the flying head slider 23, respectively, the first arm 65 and the second arm 66 are allowed to slide on the side surfaces 67 of the flying head slider 23. Curvature of the first arm 65 and the second arm 66 cannot thus be restrained. In addition, the fixation piece 62 is defined separately from the first arm 65 and the second arm 66. The first arm 65 and the second arm 66 can enjoy a wide variety of design. It is thus possible to ensure a sufficient length of the first arm 65 and the second arm 66. A larger deformation of the first arm 65 and the second arm 66 can be realized. A larger movement of the flying head slider 23 can be realized.

In addition, point contact is established between the domed surfaces 73 of the first and second arms 65, 66 and the side surfaces 67 of the flying head slider 23, respectively. The first arm 65 and the second arm 66 are designed to restrain the direction of application of the driving force within the imaginary plane 77 parallel to the bottom surface 37 of the flying head slider 23, respectively. The flying head slider 23 is allowed to reliably rotate around the rotation axis RX on the imaginary plane 77. The movement of the flying head slider 23 is thus restricted in the direction parallel to the rotation axis RX, namely in the perpendicular direction perpendicular to the imaginary plane 77. The rotation of the flying head slider 23 is restricted around the longitudinal center axis of the flying head slider 23. In other words, the driving force cannot generate a change in the roll angle of flying head slider 23. The electromagnetic transducer 36 can be kept at the flying height as designed above the surface of the magnetic recording disk 14 when the flying head slider 23 is driven to rotate around the rotation axis RX. The electromagnetic transducer 36 is allowed to enjoy an improved positioning accuracy.

All examples and conditional language recited herein are intended for pedagogical purposes to aid the reader in understanding the invention and concepts contributed by the inventor to furthering the art, and are to be construed as being without limitation to such specifically recited examples and conditions, nor does the organization of such examples in the specification relates to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A head suspension assembly comprising:
a head slider defining a medium-opposed surface on a front surface;
a fixation piece fixed to a back surface, reverse to the front surface, of the head slider;
a flexible elongated piece extending from the fixation piece, the flexible elongated piece coupled to a head suspension, the flexible elongated piece supporting the fixation piece for relative rotation around a rotation axis perpendicular to the medium-opposed surface of the head slider;
an arm having one end coupled to the head suspension, the arm having an other end defining a domed surface establishing point contact against a side surface of the head slider set perpendicular to the medium-opposed surface of the head slider, the arm designed to restrain a direction of application of a force along an imaginary plane including the back surface of the head slider; and
a piezoelectric element bonded to the arm at a position between the one end and the other end of the arm.

2. The head suspension assembly according to claim 1, wherein the force is applied in a direction within the imaginary plane.

3. The head suspension assembly according to claim 1, wherein the one end of the arm is coupled to the head suspension at a position upstream of an inflow end of the head slider, the other end of the arm received on the side surface of the head slider at a position downstream of the rotation axis.

4. The head suspension assembly according to claim 1, comprising a pair of the arms, wherein the head slider is located in a space defined between the arms.

5. A storage medium drive comprising:
a head slider defining a medium-opposed surface on a front surface;
a fixation piece fixed to a back surface, reverse to the front surface, of the head slider;
a flexible elongated piece extending from the fixation piece, the flexible elongated piece coupled to a head suspension, the flexible elongated piece supporting the fixation piece for relative rotation around a rotation axis perpendicular to the medium-opposed surface of the head slider;
an arm having one end coupled to the head suspension, the arm having an other end defining a domed surface establishing point contact against a side surface of the head slider set perpendicular to the medium-opposed surface of the head slider, the arm designed to restrain a direction of application of a force along an imaginary plane including the back surface of the head slider; and
a piezoelectric element bonded to the arm at a position between the one end and the other end of the arm.

6. A head suspension assembly comprising:
a head slider defining a medium-opposed surface on a front surface;
a fixation piece fixed to a back surface, reverse to the front surface, of the head slider, the fixation piece having a side surface extending along a plane intersecting the medium-opposed surface of the head slider;
a flexible elongated piece extending from the fixation piece, the flexible elongated piece coupled to a head suspension, the flexible elongated piece supporting the fixation piece for relative rotation around a rotation axis perpendicular to the medium-opposed surface of the head slider;
an arm having one end coupled to the head suspension, the arm having an other end defining a domed surface establishing point contact against the side surface of the fixation piece, the arm designed to restrain a direction of application of a force along an imaginary plane parallel to the medium-opposed surface of the head slider; and
a piezoelectric element bonded to the arm at a position between the one end and the other end of the arm.

7. The head suspension assembly according to claim 6, wherein the force is applied in a direction within the imaginary plane.

8. The head suspension assembly according to claim 6, wherein the imaginary plane coincides with an intermediate plane defined in the fixation piece at a position equally spaced from front and back surfaces of the fixation piece.

9. The head suspension assembly according to claim 6, comprising a pair of the arms, wherein the head slider is located in a space defined between the arms.

10. A storage medium drive comprising:
a head slider defining a medium-opposed surface on a front surface;
a fixation piece fixed to a back surface, reverse to the front surface, of the head slider, the fixation piece having a side surface extending along a plane intersecting the medium-opposed surface of the head slider;
a flexible elongated piece extending from the fixation piece, the flexible elongated piece coupled to a head suspension, the flexible elongated piece supporting the fixation piece for relative rotation around a rotation axis perpendicular to the medium-opposed surface of the head slider;
an arm having one end coupled to the head suspension, the arm having an other end defining a domed surface establishing point contact against the side surface of the fixation piece, the arm designed to restrain a direction of application of a force along an imaginary plane parallel to the medium-opposed surface of the head slider; and
a piezoelectric element bonded to the arm at a position between the one end and the other end of the arm.
